(19) United States
(12) Patent Application Publication
(10) Pub. No.: US 2003/0126520 A1
(43) Pub. Date: Jul. 3, 2003

(54) System and method for separating exception vectors in a multiprocessor data processing system

(75) Inventor: Brian James Knight, Cambridge (GB)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: GlobespanVirata, Red Bank, NJ

(21) Appl. No.: 09/683,876

(22) Filed: Feb. 26, 2002

Related U.S. Application Data
(60) Provisional application No. 60/343,197, filed on Dec. 31, 2001.

(51) Int. Cl. G06F 11/00

(52) U.S. Cl. 714/100

(57) ABSTRACT

A system and method is provided for uniquely handling exception an interrupts in at least two different processors in a multiprocessor system. Initially, the memory address identified in a common exception vector table is written to contain an instruction which copies the current version of an IRQ-mode banked register into the program counter of the processor for subsequent execution. Next, each processor initializes independent IRQ-mode registers to contain the respective addresses for their individual IRQ handler routines. Upon receipt of an interrupt request or other exception, the processor receiving the request changes to an IRQ-mode, resulting in at least one register change from a normal register to the previously initialized IRQ-mode register. Next, the processor looks in the exception vector table for the appropriate interrupt handler address location and jumps to the identified memory location. Correspondingly, the processor executes the instruction at this location and moves a processor-specific IRQ-mode banked register into the program counter. Next, the processor jumps to the address location for the calling processor's unique IRQ handling routine, written in the IRQ-mode banked register.

### CROSS REFERENCE TO RELATED APPLICATIONS

This application claims the benefit of U.S. provisional patent application Serial No. 60/343,197 filed Dec. 31, 2001, the disclosure of which is incorporated herein by reference.

### BACKGROUND OF THE INVENTION

The present invention relates generally to data processing system and, in particular, to systems and methods for handling exceptions in such data processing systems.

In conventional data processing systems, a processor operates to execute a sequence of instructions, the result of which accomplishes the tasks set before it. Unfortunately, simple sequential execution of instructions is not always possible or advantageous in systems which must be responsive to external events or errors. In certain circumstances, it is desirable to interrupt the execution of a current activity to handle a request or respond to an unexpected event. These disruptions in processor activity are commonly referred to as interrupts and exceptions.

As an example, a processor may receive an interrupt request (IRQ) from an external device. In response, the processor saves information relating to the current state of the machine, including an indication of the address of the next instruction to be executed, and then immediately transfers control to an interrupt handler which begins at some predetermined address. As another example, if an execution error such as divide-by-zero or general page fault occurs during the execution of a particular instruction, the processor may similarly save information related to the current state of the machine and transfer control to an exception handler.

It should be understood that, although the terms “exception” and “interrupt” have been used above to describe different circumstance or events, each may be treated in a similar manner by the processor. Generally speaking, an exception refers to any instruction that operates to disrupt ordinary program execution, such as an interrupt request (IRQ) or a system error. The term “exception” typically refers to internal instructions in response to unexpected events or errors (e.g., divide by zero erros, general protection faults, etc.), while the term “interrupt”, typically refers to a specific kind of exception relating to requests for access to processor resources by external devices (e.g., a PCI card, a keyboard controller, etc.). Therefore, although distinctions may exist between the different types of “exceptions”, as used herein, the terms interrupt and exception are used interchangeably.

Each type of exception recognized by the processor has associated therewith a unique vector number. Further, each recognized exception also has associated therewith an exception service routine (commonly referred to as an exception handler) saved at a particular location within the system's memory. The exception handler routine includes the code necessary for the processor to “handle” the exception. Upon receipt of an interrupt or exception, the processor saves information relating to the current state of the machine onto a system stack. This enables the processor to properly return to the current activity following execution of the appropriate exception service routine. The processor then vectors to the memory location of the appropriate exception handler and executes the code contained therein. Once the exception has been handled, the processor retrieves the saved current state information from the system stack and resumes operation of the original program. Several techniques are known for identifying the entry point for each exception handler.

In one technique, a table of addresses is created, typically starting at a memory address of 0 within the system's memory and commonly referred to as an exception vector table. Each entry in the exception vector table is the same length as the length of an memory location address (e.g., two or four bytes) and contains the entry point for a corresponding vector number. When an interrupt or exception occurs, the processor first determines the base address of the table, then adds m times the vector number (where m is the number of bytes in each entry). The processor then loads the information stored at the resulting address into the program counter (PC) enabling transfer of control to the associated exception handier routine beginning at the address specified in the table entry. The program counter is a register in the processor that contains the address of the next instruction to be executed. In other systems, an entire branch instruction is stored in each entry in the exception vector table, instead of merely the address of a handler. The number of bytes in each entry is equal to the number of bytes in a branch instruction. When an interrupt or exception is received, the processor, as above, determines the table base address, adds m times the vector number, and loads the result into the PC. Since this result includes the branch instruction itself, this instruction is executed and control is finally transferred to the appropriate exception handler following execution of the branch instruction.

Further, provisions have been made for circumstances in which two or more exceptions occur at the same time. Conventionally, a priority system is used to determine the order in which the exceptions are handled. When the processor executes an exception handler, all exceptions having the same or lower priority are disabled until the handler has finished. This means that even an exception handler can be interrupted by an exception having a higher priority level. The processor can also disable interrupts during crucial parts in a program, thus ensuring that the current activity is completed in sequence.

While the above-described scenarios are suitable for systems having a single processor or multiple processors having non-shared memory, a problem can occur in systems having two or more processors sharing a common memory system. In particular, a conflict may occur if any two processors in the system both expect their exception and interrupt vectors to reside at a fixed memory address but expect different exception handlers to be executed. Under conventional methodologies, each exception vector table points to a single handler address, resulting in the same routine regardless of which processor is accessing the table.

Therefore, there is a need in the art of multiprocessor data processing systems for an improved system and method for handling exceptions where each processor shares a common memory system.

### SUMMARY OF THE INVENTION

The present invention overcomes the problems noted above, and provides additional advantages, by providing a system and method for uniquely handling exception an interrupts in at least two different processors in a multiprocessor system. Initially, the memory address identified in a common exception vector table is written to contain an instruction which copies the current version of an IRQ-mode banked register into the program counter of the processor for subsequent execution. Next, each processor initializes independent IRQ-mode registers to contain the respective addresses for their individual IRQ handler routines.

Upon receipt of an interrupt request or other exception, the processor receiving the request changes to an IRQ-mode, resulting in at least one register change from a normal register to the previously initialized IRQ-mode register. Next, the processor looks in the exception vector table for the appropriate interrupt handler address location and jumps to the identified memory location. Because this memory location has been previously written to include an instruction which copies the current version of an IRQ-mode banked register into the program counter, the processor executes the instruction, resulting in the calling of a processor-specific IRQ-mode banked register. Next, because the IRQ-mode banked register has been written to include the address location for the calling processor's unique IRQ handling routine, the processor next jumps to this routine. By utilizing the existence of banked registers, the technique of the present invention allows each processor to access a distinct set of exception handling routines, even though each is forced to execute exactly the same instructions in shared memory.

### BRIEF DESCRIPTION OF THE DRAWINGS

FIG. 1 is a simplified block diagram of a multiprocessor data processing system incorporating the exception and interrupt handling methodology of the present invention.

FIG. 2 is a flow diagram illustrating one embodiment of a method for uniquely handling interrupt requests from at least two different processors according to the present invention.

### DETAILED DESCRIPTION OF THE PREFERRED EMBODIMENTS

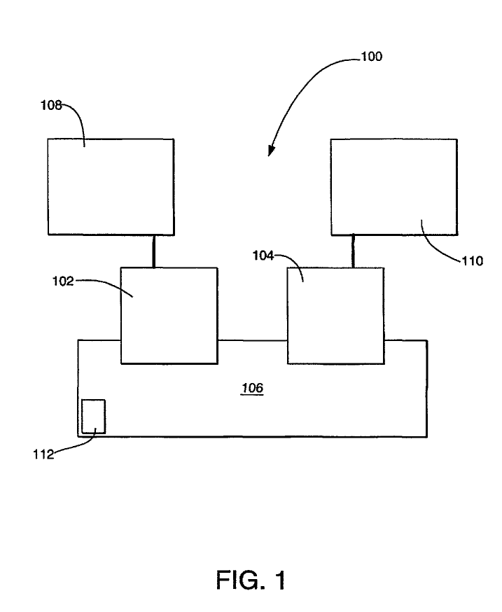

Referring now to the Figures and, in particular, to FIG. 1, there is shown one embodiment of a multiprocessor system 100 incorporating the present exception handling system. In particular, system 100 includes a first processor 102 and a second processor 104. In one example, such processors may include RISC (Reduced Instruction Set Computing) processors manufactured by Advanced RISC Machines Limited (ARM) of Cambridge, UK. Further, processors 102 and 104 share a common memory system 106. In one embodiment, a first device 108 is connected to processor 102, while a second device 110 is connected to processor 104. Each ARM processor 102 and 104 uses a table of exception and interrupt vectors 112 which is maintained in the eight words of memory starting at memory address 0, with each address contained within the table 112 corresponding to a specific exception or interrupt. Upon occurrence of an exception or interrupt, the processor receiving the exception (either processor 102 or processor 104) calls the word contained at the corresponding location in table 112. The following illustrates one example of a exception vector table for use by ARM processors:

| | |
|---|---|
| 0x00000000 | Reset |
| 0x00000004 | Undefined Instruction |
| 0x00000008 | Software Interrupt |
| 0x0000000C | Prefetch Abort |
| 0x00000010 | Data Abort |
| 0x00000014 | Reserved |
| 0x00000018 | Interrupt |
| 0x0000001C | Fast Interrupt |

In a conventional manner, each device 108 and 110 notifies its respective processor that it requires service through a signal on the processor's IRQ pin. In response to this signal, the notified processor would generate an interrupt exception and determine the proper exception handler to call based upon the information in the exception vector table maintained in the shared memory 106. As described above, because each processor looks for exception vector address information in the same location in exception vector table 112 in shared memory 106, each processor would, under a conventional system, call the same exception handler routine in response to two different requests. For example, using the above table, the word at address 0x00000018 is executed when an IRQ (interrupt request) occurs on either processor. In conventional systems, this word holds a branch instruction to transfer control to an IRQ handler routine, and may take a form such as “b IRQhandler”. Consequently, each processor would respond to its IRQ signal by executing the same branch instruction from address 0x00000018 and so would jump to the same interrupt handler routine in shared memory 106. For the reasons specifically set forth above, this result is undesirable since each processor would typically require the execution of different handler routines in response to respective exceptions.

In order to overcome the above-described erroneous result, the system of the present invention enables exceptions generated in specific processors to vector to individual handler routines, although continuing to utilize a single shared exception vector table 112 common to all processors in the shared memory 106. In particular, the present invention achieves this objective by exploiting a plurality of banked registers which are selected according to an individual processor's mode of operation. These registers are the processor's general purpose registers and are conventionally used for holding data values, memory addresses (pointers), operands and results of calculations, etc.

In the specific case of ARM processors, there are 16 such registers available at any one time labeled r0 to r15. Two of these, r14 and r15 are treated specially by the processor hardware, where r15 is the program counter (PC) and r14 is the link register, which is used to record the return address after a subroutine call or an exception. The other registers are all general purpose, with r13 being conventionally used as a stack pointer.

Some of the general purpose registers are banked registers and have multiple copies resident on the system. The copy of the register accessible to a processor at any moment depends on the mode of operation that the processor is operating in at that time. ARM processors includes several modes of operation. For example, “user” and “system” modes are used for normal program execution. In addition, each of the exceptions (IRQ, data abort, etc.) has a corresponding processor mode each having private banked copies of the r13 and r14 registers. For example, in an IRQ-mode, registers r0 to r12 remain the same as the ones used by the processor during normal operation. However, upon entering IRQ-mode, registers r13 and r14 are replaced by corresponding banked IRQ-mode-specific registers (i.e., r13_irq and r14_irq).

When an exception is generated, the processor automatically changes to the appropriate mode and stores the return address (i.e. the address where execution was interrupted) in that mode's r14 register. This means that none of the interrupted program's registers are corrupted (as a particular exception/interrupt should never be generated while handling one of the same type).

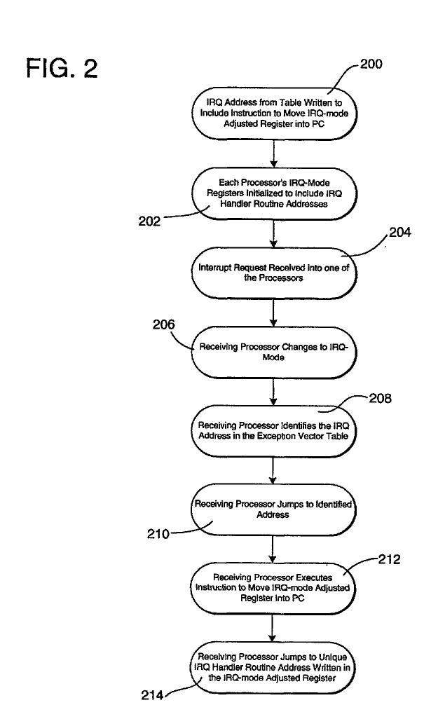

Referring now to FIG. 2, there is shown a flow diagram illustrating one embodiment of a method for enabling multiple processors to separate exception vectors in accordance with the present invention. Initially, in step 200, the word at address 0x00000018 of the common exception vector table (i.e., the IRQ field in the table) is written to contain an instruction which copies the current version of an IRQ-mode banked register (e.g., r13 in the ARM example described above) into the program counter (PC) of the processor, resulting in a jump to any address contained within the register. In one embodiment, this instruction may take the form “mov pc, r13”, indicating that the processor should read the contents of the r13 register into the PC upon receiving an interrupt request. It should be understood, however, that any suitable form of instruction may be utilized.

Next, in step 202, each processor initializes independent IRQ-mode registers (e.g., r13_irq in the ARM example above) to contain the address of the IRQ handler routine associated with the particular IRQ for the respective processor. Such initialization step preferably occur during boot up (i.e., startup and initialization) of the processors, however, it should be understood that this initialization may occur at any suitable time prior to the occurrence of an exception or interrupt within the processor.

Once initialized, the processors operate conventionally, until an interrupt request (IRQ) is received from an attached device in step 204. In response to the IRQ, the processor receiving the request, in step 206, changes to IRQ-mode, resulting in a register change from a normal register to the IRQ-mode register initialized in step 202. That is, in the example set forth above, the processor shifts modes so that, upon request, it will use IRQ-mode registers r13_irq and r14_irq rather than normal registers r13 and r14. Next, in step 208, the processor looks in the exception vector table for the appropriate interrupt handler address location. As in the above example, this address location may be location 0x00000018 in the shared memory.

As set forth above, the word at address 0x00000018 instructs the calling processor to copy the contents of the current r13 register (i.e., the r13_irq register in the IRQ-mode) into the program counter. Consequently, in step 210, the processor, using the address set forth in the exception vector table, jumps to the appropriate address in memory. Next, in step 212, the processor executes the instruction at the memory location to move the processor's current IRQ-mode banked register into the program counter. The IRQ-mode banked register further includes an address location for the calling processor IRQ handling routine. Thus, in step 214, the processor jumps to the address written in the processor's IRQ-mode banked register (i.e., the processor's IRQ handler routine).

This technique allows each processor to access a distinct set of exception handling routines, even though each is forced to execute exactly the same instructions in shared memory. The technique has no penalty in execution time (as the mov instruction takes a substantially identical amount of execution time as the conventional branch instruction it replaces). Further, the above methodology also has no penalty in the form of restrictions in register usage on the programs executing in the two processors. It should be understood that, although the description above relates specifically to a two processor system, the present invention is equally applicable to systems having more than two processors.

An alternative embodiment to the present invention involves replacing the above step 202 initializing banked IRQ-mode registers with a step of initializing a common (i.e., unbanked) register to hold the addresses of the processor specific IRQ handler routines. However, these reserved registers would have to maintain constant values, so programs would not be allowed to use those registers at all during normal execution. Accordingly, this result is not as beneficial as the earlier described embodiment.

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

What is claimed is:

1. A method for separating exception vectors in a data processing system having at least two processors, comprising the steps of:
receiving an exception request into one of the at least two processors;
entering, in the processor receiving the exception request, an exception mode relating to the received exception request;
calling an instruction located at a portion of an exception vector table associated with the type of exception request received, wherein the instruction causes the moving of a register into a program counter register of the processor receiving the exception request; and
executing a processor-specific exception handling routine relating to the received exception request, the address of the processor-specific exception handling routine being maintained in the register.

2. The method of claim 1, wherein the step of entering an exception mode, further comprises the step of replacing a normal register in the processor receiving the exception request with a processor-specific exception mode banked register.

3. The method of claim 2, wherein the register moved into the program counter is the processor-specific exception mode banked register.

4. The method of claim 1, further comprising the step of initializing the processor-specific exception mode banked register to contain the address of the exception handling routine.

5. The method of claim 1, wherein the exception request is an interrupt request (IRQ).

6. The method of claim 5, wherein the processor-specific exception mode banked register is a processor-specific IRQ mode banked register.

7. The method of claim 1, wherein the instruction located at a portion of an exception vector table associated with the type of exception request received, is an instruction taking the form “move pc, r13”, indicating that the contents of the r13 register are to be moved into the program counter register.

8. The method of claim 1, wherein the at least two processor are reduced instruction set computing (RISC) processors.

9. A data processing system for separating exception vectors, comprising:
at least two processors for executing a plurality of instructions;
a memory shared by the at least two processors, the memory containing at least an exception vector table common to the at least two processors;
means for receiving an exception request into one of the at least two processors;
means for entering, in the processor receiving the exception request, an exception mode relating to the received exception request;
means for calling an instruction located at a portion of the exception vector table associated with the type of exception request received, wherein the instruction causes the moving of a register into a program counter register of the processor receiving the exception request; and
means for executing a processor-specific exception handling routine relating to the received exception request, the address of the processor-specific exception handling routine being maintained in the register.

10. The data processing system of claim 9, wherein the means for entering an exception mode, further comprise means for replacing a normal register in the processor receiving the exception request with a processor-specific exception mode banked register.

11. The data processing system of claim 10, wherein the register moved into the program counter is the processor-specific exception mode banked register.

12. The data processing system of claim 9, further comprising means for initializing the processor-specific exception mode banked register to contain the address of the exception handling routine.

13. The data processing system of claim 9, wherein the exception request is an interrupt request (IRQ).

14. The data processing system of claim 13, wherein the processor-specific exception mode banked register is a processor-specific IRQ mode banked register.

15. The data processing system of claim 9, wherein the instruction located at a portion of an exception vector table associated with the type of exception request received, is an instruction taking the form “move pc, r13”, indicating that the contents of the r13 register are to be moved into the program counter register.

16. The data processing system of claim 9, wherein the at least two processor are reduced instruction set computing (RISC) processors.

17. A computer readable medium incorporating one or more instructions for separating exception vectors in a data processing system having at least two processors, the instructions comprising:
one or more instructions for receiving an exception request into one of the at least two processors;
one or more instructions for entering, in the processor receiving the exception request, an exception mode relating to the received exception request;
one or more instructions for calling an instruction located at a portion of an exception vector table associated with the type of exception request received, wherein the instruction causes the moving of a register into a program counter register of the processor receiving the exception request; and
one or more instructions for executing a processor-specific exception handling routine relating to the received exception request, the address of the processor-specific exception handling routine being maintained in the register.

18. The computer readable medium of claim 17, wherein the one or more instructions for entering an exception mode, further comprises one or more instructions for replacing a normal register in the processor receiving the exception request with a processor-specific exception mode banked register.

19. The computer readable medium of claim 18, wherein the register moved into the program counter is the processor-specific exception mode banked register.

20. The computer readable medium of claim 17, the instructions further comprising one or more instructions for initializing the processor-specific exception mode banked register to contain the address of the exception handling routine.

21. The computer readable medium of claim 17, wherein the exception request is an interrupt request (IRQ).

22. The computer readable medium of claim 21, wherein the processor-specific exception mode banked register is a processor-specific IRQ mode banked register.

23. The computer readable medium of claim 17, wherein the instruction located at a portion of an exception vector table associated with the type of exception request received, is an instruction taking the form “move pc, r13”, indicating that the contents of the r13 register are to be moved into the program counter register.

24. The computer readable medium of claim 17, wherein the at least two processor are reduced instruction set computing (RISC) processors.
